(19) United States
(12) Patent Application Publication
(10) Pub. No.: US 2019/0050742 A1
(43) Pub. Date: Feb. 14, 2019

(54) COMPATIBILITY PREDICTION TECHNOLOGY IN SHARED VEHICLES

(71) Applicant: Intel Corporation, Santa Clara, CA (US)

(72) Inventors: Daria Loi, Portland, OR (US); Giuseppe Raffa, Portland, OR (US); Lama Nachman, Santa Clara, CA (US)

(21) Appl. No.: 15/857,930

(22) Filed: Dec. 29, 2017

(51) Int. Cl. G06N 5/04; G06F 17/30

(52) U.S. Cl. CPC G06N 5/04; G06N 99/005; G06F 17/30528

(57) ABSTRACT

Systems, apparatuses and methods may provide for technology that automatically detects a user reaction of a first occupant of a shared vehicle based on first data from one or more sensors associated with the shared vehicle. Additionally, the technology may automatically determine a root cause of the user reaction based on one or more of the first data or second data. In one example, co-occupant selection criteria associated with the first occupant is automatically updated if the root cause is a second occupant of the shared vehicle.

### TECHNICAL FIELD

Embodiments generally relate to shared vehicle technology. More particularly, embodiments relate to compatibility prediction technology in shared vehicles.

### BACKGROUND

Autonomous vehicle ecosystems may provide fleets of automated vehicles that are owned and/or operated by ride sharing services rather than individual passengers or drivers. In such ecosystems, passengers may be matched together based on common departure locations, destinations and/or schedules. Sharing small spaces for extended periods of time, however, may present interpersonal challenges from a passenger perspective, particularly when the passengers lack a pre-existing relationship. These challenges may in turn present challenges to autonomous vehicle providers. For example, incompatible needs, behaviors, likes and/or dislikes between co-passengers may impede the deployment of autonomous vehicle ecosystems on a wide scale.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a shared vehicle cabin according to an embodiment;

FIG. 2 is a block diagram of an example of a shared vehicle ecosystem according to an embodiment;

FIG. 3 is a flowchart of an example of a method of maintaining co-occupant selection criteria according to an embodiment;

FIG. 4 is a flowchart of an example of a method of determining a root cause of a user reaction according to an embodiment;

FIG. 5 is a flowchart of an example of a method of updating co-occupant selection criteria according to an embodiment;

FIG. 6 is a flowchart of an example of a more detailed method of maintaining co-occupant selection criteria according to an embodiment;

FIG. 7 is a block diagram of an example of a mobile system according to an embodiment; and

FIG. 8 is an illustration of an example of a semiconductor package apparatus according to an embodiment.

### DESCRIPTION OF EMBODIMENTS

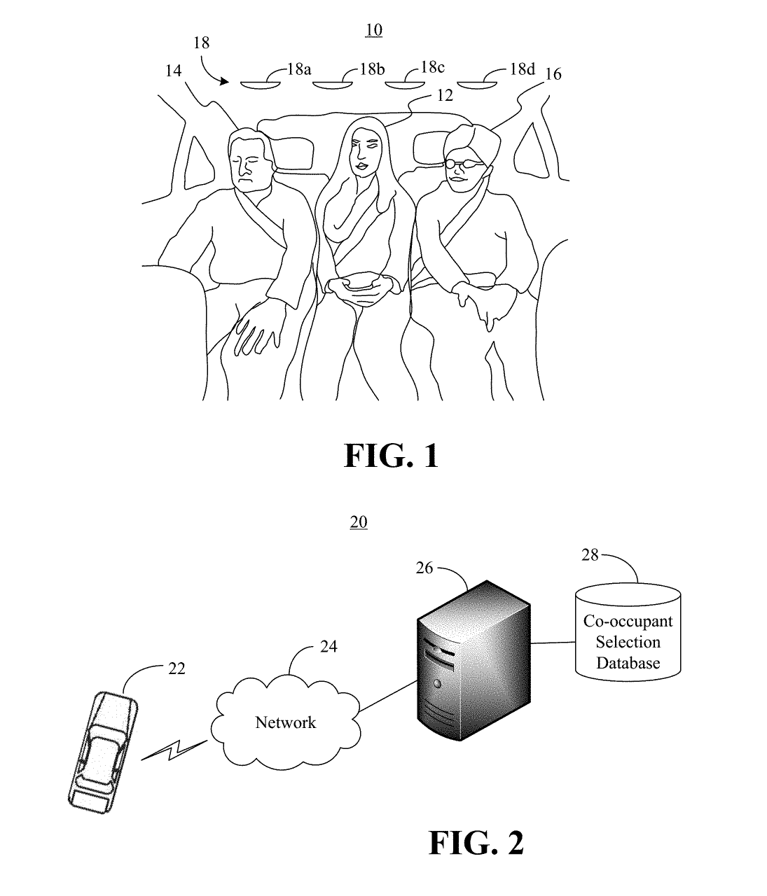

Turning now to FIG. 1, a shared vehicle cabin 10 is shown in which a first occupant 12, a second occupant 14 and a third occupant 16 are confined to a relatively small physical space. In one example, the cabin 10 is part of an autonomous (e.g., driverless) shared vehicle (e.g., mobile system) that transports the occupants 12, 14, 16 (e.g., passengers) for potentially extended periods of time or recurring trips (e.g., commutes to work, commutes from work, trips). Moreover, the autonomous shared vehicle may be owned and/or operated by a ride sharing service. Accordingly, the occupants 12, 14, 16 may have either no pre-existing relationship or a minimal pre-existing relationship. The illustrated cabin 10 is equipped with a plurality of sensors 18 (18a-18b, e.g., sensor array) that capture information/data regarding the behavior and/or status of the occupants 12, 14, 16, while sharing the cabin 10.

For example, a first sensor 18a may be an internal camera that captures still images and/or video of the interior of the cabin 10, a second sensor 18b may be an internal microphone that records conversations and/or other sounds within the cabin 10, a third sensor 18c may be a chemical sensor that measures compounds, gases, etc., of the ambient air within the cabin 10, a fourth sensor 18d may be a motion sensor (e.g., accelerometer, gyroscope) that measures the movement (e.g., bumps, swerves, sudden stops) of the cabin 10, and so forth. The shared vehicle may also be equipped with other sensors (e.g., external sensors, not shown). As will be discussed in greater detail, data/signals collected from the sensors 18 may be used to automatically detect user reactions of the occupants 12, 14, 16 to their surroundings. Additionally, data collected from the sensors 18 and/or other (e.g., external) sensors may be used to automatically determine the root causes of the user reactions. Moreover, if the root cause of a detected reaction is another occupant 12, 14, 16, then co-occupant selection criteria associated with the occupant manifesting the user reaction may be automatically updated. Detecting, capturing and logging user reactions in such a fashion may significantly enhance the performance of the shared vehicle from the perspective of the occupants 12, 14, 16 and/or the owner/operator of the shared vehicle.

For example, video footage from the first sensor 18a might be analyzed to automatically determine that the expression on the face of the first occupant 12 has changed from a neutral expression to a frown. Facial recognition techniques to make such a determination might involve the use of, for example, facial contour analysis that takes into consideration training data collected from a relatively wide set of training subjects. Determining the root cause of the frown may involve analyzing, for example, audio data captured by the second sensor 18b to detect that the second occupant 14 made an offensive (e.g., off-color, discriminatory, insulting, profane) remark moments before the first occupant 12 frowned. The identity of the individual making the remark as well as the nature of the remark may be determined using audio recognition techniques that include, for example, audio frequency, tone, pitch and/or volume analysis, as well as natural language analysis. Once the root cause of the user reaction is determined, the co-occupant selection (e.g., passenger “matchmaking”) criteria corresponding to the first occupant 12 might be updated to reflect that, because the first occupant 12 had a negative reaction to the second occupant 14, the first occupant 12 is not to be paired with the second occupant 14 for future rides.

In another example, audio data from the second sensor 18b may be analyzed to automatically determine that the third occupant 16 has made a verbal remark about an unpleasant smell in the cabin 10. In such a case, chemical analysis data from the third sensor 18c may be used to automatically determine that the smell originated from the second occupant 14. Therefore, the co-occupant selection criteria corresponding to the third occupant 16, may be updated to reflect that, because the third occupant 16 had a negative reaction to the odor of the second occupant 14, the third occupant 16 is not to be paired with the second occupant 14 for future rides.

Other types of root causes (e.g., ride conditions) may be automatically detected and added to the co-occupant selection criteria. For example, the root cause of a user reaction might include:

vehicle appearance (e.g., cleanness, inappropriate items, torn seats);

occupant gender or age in relation to passenger;

occupant behavior while entering/exiting the vehicle (e.g., intoxication);

occupant physical build (e.g., oversized) and/or posture (e.g., leg spreading) in relation to vehicle size and available space in the cabin 10;

occupant communication style and verbal behavior (e.g., loud or too chatty when passenger trying to work or rest);

occupant general hygiene appearance;

occupant preference in terms of routes, driving style, etc.

Of particular note is that positive user reactions may also be automatically detected and used to determine root causes and maintain co-occupant selection criteria. For example, video footage from the first sensor 18a may be analyzed to automatically determine (e.g., via facial recognition) that the expression on the face of the first occupant 12 has changed from a frown to a prolonged smile. Determining the root cause of the smile might involve analyzing audio data captured by the second sensor 18b to detect (e.g., via audio frequency, tone, volume, tone and/or natural language analysis) that the first occupant 12 and the third occupant 16 engaged in an extended conversation while the first occupant 12 was smiling. Once the root cause of the user reaction is determined, the co-occupant selection criteria corresponding to the first occupant 12 may be updated to reflect that, because the first occupant 12 had a positive reaction to the third occupant 16, the first occupant 12 may be paired with the third occupant 16 for future rides.

The user reaction and root cause information may be coupled with co-occupant evaluations (e.g., passenger voting data) to enhance the meaning of (e.g., add context to) the evaluations. For example, rather than simply logging a one star rating of the second occupant 14 by the first occupant 12, the technology described herein would enable the one star rating to be automatically annotated with the fact that the second occupant 14 made a remark that offended the first occupant 12. Accordingly, future pairings of the first occupant 12 with other passengers may exclude passengers having a history of making offensive remarks. Indeed, the specific type of remark and/or the remark itself may also be included in the co-occupant selection criteria and the passenger pairing analysis. In this regard, the technology described herein is able to account for the fact that different passengers may have different sensitivities, needs, likes and/or dislikes. While the co-occupant selection criteria are described herein as co-passenger selection criteria (e.g., passenger-to-passenger pairing criteria), if the shared vehicle is not autonomous, the co-occupant selection criteria may also include driver information (e.g., passenger-to-driver pairing criteria and/or driver-to-passenger pairing criteria).

FIG. 2 shows a shared vehicle ecosystem 20 that includes a shared vehicle 22 in wireless communication with a network 24 coupled to a ride sharing service 26 (e.g., collection of cloud computing infrastructure servers). The shared vehicle 22 may include surfaces defining a cabin such as, for example, the cabin 10 (FIG. 1), already discussed. In one example, the cellular network 24 is a GSM (Global System for Mobile Communications), W-CDMA (Wideband Code-Division Multiple Access), LTE (Long Term Evolution), 5G (5^{th} Generation Mobile Network) and/or other suitable network. The illustrated ride sharing service 26 may maintain a database 28 of co-occupant selection criteria as described herein.

The database 28 may generally reflect/document the attributes of multiple occupants, inside and outside the shared vehicle 22, over time. The database 28 may be organized as a relational database, a set of occupant profiles and/or any other suitable data structure. Additionally, portions of the database 28 may be deconstructed and/or distributed. For example, personal data might be decoupled from the passenger matching rules/heuristics. Moreover, portions of the database 28 may be located elsewhere such as, for example, in the shared vehicle 22, in an edge network component (not shown), etc.

In one example, the shared vehicle 22 automatically detects user reactions of occupants of the shared vehicle 22 based on sensors mounted to the shared vehicle 22, automatically determines the root causes of the user reactions based on the user reactions and/or additional data (e.g., real-time data from the sensors mounted to the shared vehicle and/or previously collected data retrieved from storage), automatically determines additional co-occupant selection criteria, and sends one or more update messages/instructions to the ride sharing service 26 based on the additional co-occupant selection criteria. In another example, the ride sharing service 26 automatically determines the co-occupant selection criteria by analyzing user reaction and root cause information received from the shared vehicle 22. In yet another example, the ride sharing service 26 automatically determines the root causes based on user reaction and/or sensor information received from the shared vehicle.

Thus, the ride sharing service 26 may receive sharing requests and use machine learning (ML) and/or deep learning (DL, e.g., convolutional neural network/CNN, recurrent neural networks/RNN, etc.) techniques to automatically determine matches between occupants based on the compatibility of their profiles and the current context. The ride sharing service 26 may also inform passengers of “better matches” if certain sharing request parameters (e.g., start time) are relaxed.

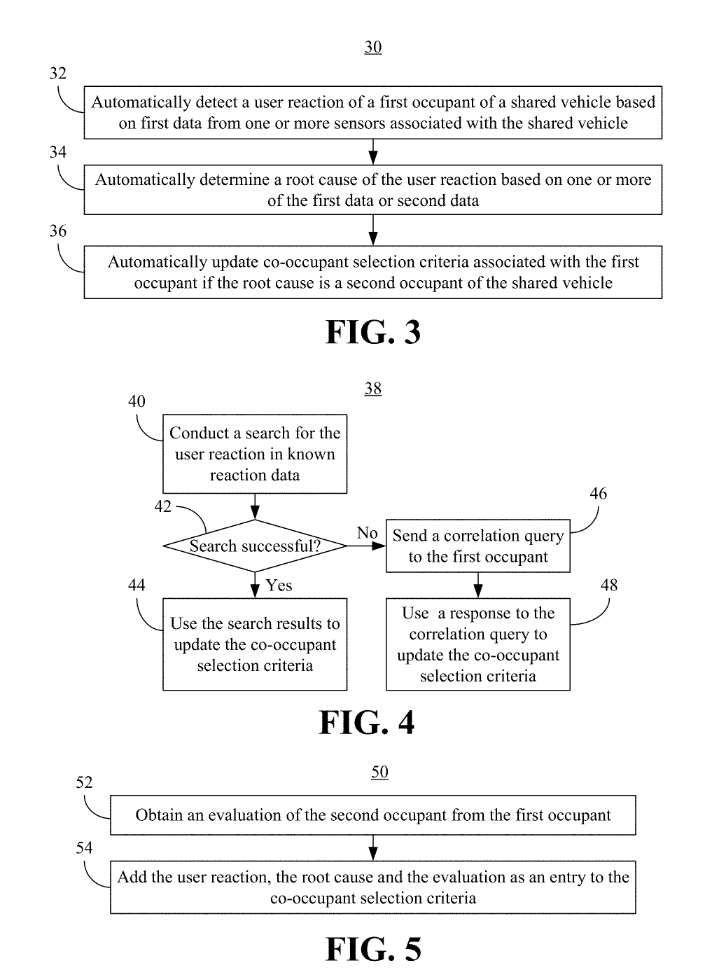

FIG. 3 shows a method 30 of maintaining co-occupant selection criteria. The method 30 may generally be implemented in a mobile system such as, for example, the shared vehicle 22 (FIG. 2) and/or the ride sharing service 26 (FIG. 2), already discussed. More particularly, the method 30 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 30 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 32 automatically detects a user reaction of a first occupant of a shared vehicle based on first data from one or more sensors associated with the shared vehicle. Block 34 may automatically determine a root cause of the user reaction based on one or more of the first data or second (e.g., additional) data. The first and second data/signals may be collected from, for example, an internal camera, an external camera, an internal microphone, an external microphone, an internal chemical sensor, an external chemical sensor, a motion sensor, a storage device (e.g., non-volatile memory/NVM and/or volatile memory), etc., or any combination thereof. Indeed, the data to be analyzed may precede the user reaction. Thus, block 34 may capture and maintain a sliding window of sensor data so that analysis can be conducted after a user reaction is detected. Real-time sensor data may be particularly useful when detecting persistent conditions (e.g., odor), whereas data collected and stored before the user reaction has been detected may be more useful when detecting transient conditions (e.g., offensive remarks).

Block 36 may provide for automatically updating co-occupant selection criteria associated with the first occupant if the root cause is a second occupant of the shared vehicle. The co-occupant selection criteria may include, for example, co-passenger selection criteria. The method 30 may also provide for initiating a safety measure with respect to the shared vehicle if the root cause poses a threat to the first occupant. The safety measure might include, for example, stopping the shared vehicle, notifying the police, sounding an alarm mounted to the vehicle, unlocking a self-defense mechanism (e.g., conducted electrical weapon/CEW, TASER, etc.) within the cabin of the shared vehicle, etc., or any combination thereof.

FIG. 4 shows a method 38 of determining a root cause of a user reaction. The method 38 may generally be implemented in a shared vehicle such as, for example, the shared vehicle 22 (FIG. 2) and/or the ride sharing service 26 (FIG. 2), already discussed. More particularly, the method 42 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 40 provides for conducting a search for the user reaction in known reaction data. The known reaction data may include an accumulation of user reactions previously detected with respect to the passenger in question (e.g., the first occupant) and/or user reactions previously detected with respect to training set of passengers. The search input may include the user reaction, the sensor data used to detect the user reaction and/or additional sensor data. For example, if video footage from an internal camera indicates that the first occupant has been smiling while looking through the vehicle window, block 40 might collect data from an external camera to determine the ambient scenery (e.g., botanical garden). In such a case, the botanical garden may be used as a search term.

In another example, if audio data from the vehicle cabin indicates that the first occupant has made an uncomfortable sigh, block 40 may extract information from internal video footage to automatically determine that, for example, another occupant is sitting unusually close to the first occupant. In such a case, the close proximity of the other occupant may be used as a search term. Illustrated block 42 determines whether the search of the known reaction data was successful. Thus, block 42 might determine whether ambient scenery has previously caused a smile, close passenger proximity has previously caused an uncomfortable sigh, etc., with respect to the first occupant. If the search was successful, block 44 may use the search results to update the co-occupant selection criteria (e.g., log an additional instance of the botanical garden causing a smile, the close passenger proximity causing an uncomfortable sigh, etc.).

If the search was unsuccessful, block 46 may send a correlation query to the first occupant. The correlation query may generally prompt the first occupant for confirmation of the root cause, especially if the calculated accuracy from the ML system is below a certain “confidence level” threshold. For example, the correlation query might be a text (e.g., short messaging service/SMS) message asking “Are you smiling at the botanical garden?” or an instant message (IM) asking “Is the passenger next to you too close?” The correlation query may therefore include the data selected from the internal and/or external sensors of the shared vehicle. The correlation query may also be sent during or after the ride, and via different communication modes (e.g., text message, IM, email, etc.), depending on the circumstances. A response to the correlation query may be used at block 48 to update the co-occupant selection criteria.

FIG. 5 shows a method 50 of updating co-occupant selection criteria. The method 50 may generally be substituted for block 36 (FIG. 3), already discussed. More particularly, the method 50 may be implemented in a shared vehicle such as, for example, the shared vehicle 22 (FIG. 2) and/or the ride sharing service 26 (FIG. 2), already discussed. The method 50 may therefore be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 52 obtains an evaluation of the second occupant from the first occupant. Block 52 may include prompting (e.g., via text message, IM, email, etc.) the first occupant for voting input (e.g., “Rate your co-passenger”). The user reaction, the root cause and the evaluation may be added as an entry to the co-occupant selection criteria at block 54. Thus, block 52 might indicate that the second occupant received a one star rating from the first occupant because the second occupant made an offensive remark to the first occupant during a ride. The illustrated method 50 therefore provides a more contextualized voting solution that leverages sensor information collected in and around the shared vehicle.

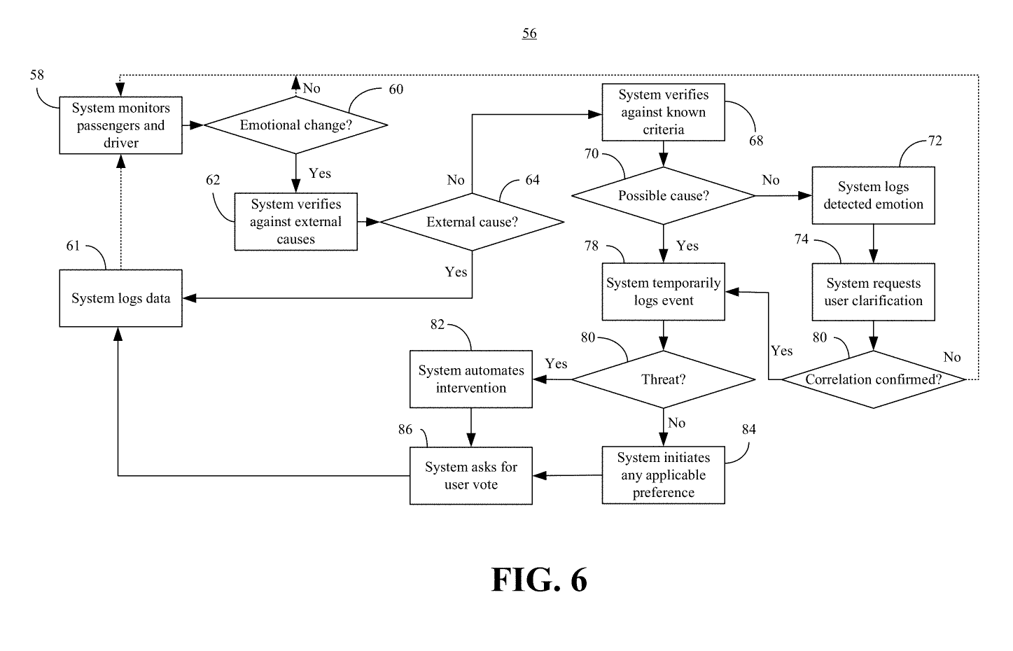

FIG. 6 shows a more detailed method 56 of maintaining co-occupant selection criteria. The method 56 may generally be implemented in a shared vehicle such as, for example, the shared vehicle 22 (FIG. 2) and/or the ride sharing service 26 (FIG. 2), already discussed. The method 56 may therefore be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 58 monitors (e.g., via one or more internal sensors) the passengers and driver of a shared vehicle. A determination may be made at block 60 as to whether an emotional change (e.g., user reaction) has been detected with respect to a passenger. If not, the illustrated method 56 returns to block 58. Otherwise, block 62 may verify the emotional change against external causes. Block 62 may therefore include analyzing data/signals from one or more external sensors of the shared vehicle. A determination may therefore be made at block 64 as to whether the root cause of the emotional change is external to the shared vehicle. If so, the emotional change and the root cause may be logged at block 61 and the illustrated method 56 returns to block 58. If the root cause of the emotional change is not external to the shared vehicle, block 68 may verify the emotional change against known criteria (e.g., searching known reaction data for the user reaction).

Illustrated block 70 determines whether a possible root cause has been found. If not, the detected emotion may be logged at block 72, wherein user clarification may be requested at block 74. A determination may be made at block 76 as to whether a correlation has been confirmed. If not, the method 56 may return to block 58. Otherwise, illustrated block 78 temporarily logs the emotional change and the root cause. If it is determined at block 70 that a possible root cause has been found via the verification of block 68, the illustrated method 56 proceeds directly to block 78.

Block 80 may determine whether the root cause poses a threat to the passenger. If so, an intervention may be automated at block 82. Block 82 may include, for example, stopping the shared vehicle, notifying the police, sounding an alarm mounted to the vehicle, unlocking a self-defense mechanism within the cabin of the shared vehicle, and so forth. If no threat is detected at block 80, illustrated block 84 initiates any applicable preference. Block 86 may prompt for a user vote (e.g., evaluation of co-occupants), wherein the data may be logged at block 61.

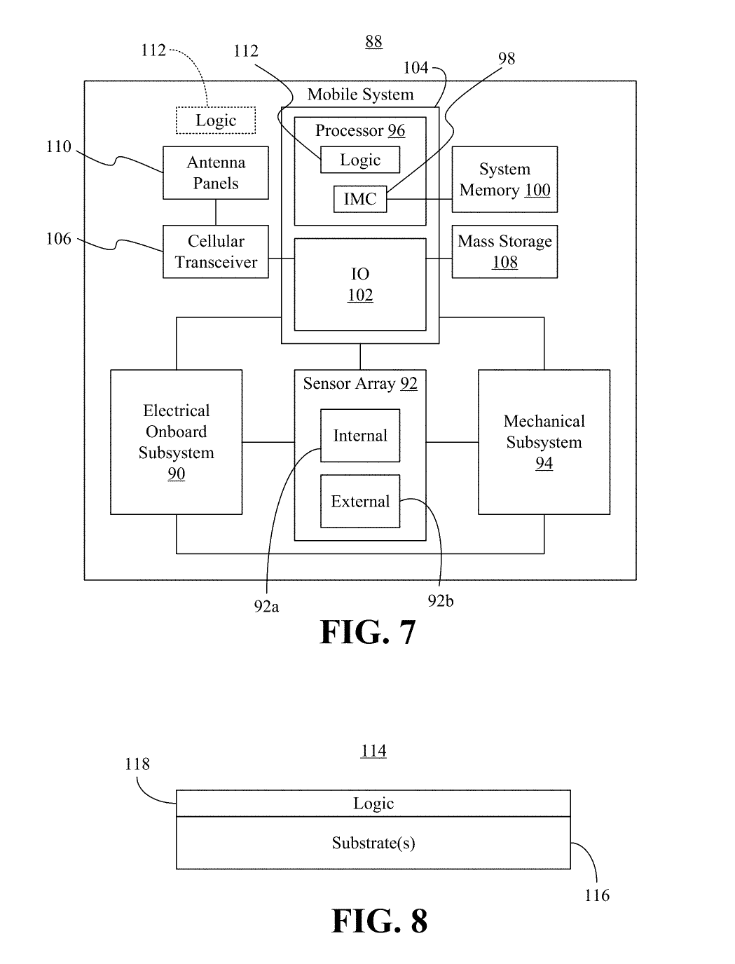

Turning now to FIG. 7, a compatibility-enhanced mobile system 88 is shown. The mobile system 88 may be an autonomous shared vehicle such as, for example, an autonomous car, airplane, spacecraft, and so forth. The mobile system 88 may readily be substituted for the shared vehicle 22 (FIG. 2), already discussed. In the illustrated example, the system 88 includes an electrical onboard subsystem 90 (e.g., instrument panels, embedded controllers), a sensor array 92 (92a, 92b), a mechanical subsystem 94 (e.g., drivetrain, internal combustion engines, fuel injectors, pumps, etc.) and one or more processors 96 (e.g., host processor(s), central processing unit(s)/CPU(s) with one or more processor cores) having an integrated memory controller (IMC) 98 that is coupled to a system memory 100.

The illustrated mobile system 88 also includes an input output (IO) module 102 implemented together with the processor(s) 96 on a semiconductor die 104 as a system on chip (SoC), wherein the IO module 102 functions as a host device and may communicate with, for example, a cellular transceiver 106 (e.g., GSM, W-CDMA, LTE, 5G), and mass storage 108 (e.g., hard disk drive/HDD, optical disk, solid state drive/SSD, flash memory). The cellular transceiver 106 may be coupled to a plurality of antenna panels 110. The processor(s) 96 may include logic 112 (e.g., logic instructions, configurable logic, fixed-functionality hardware logic, etc., or any combination thereof) to perform one or more aspects of the method 30 (FIG. 3), the method 38 (FIG. 4), the method 50 (FIG. 5) and/or the method 56 (FIG. 6), already discussed.

Thus, the logic 112 may automatically detect a user reaction of a first occupant of the mobile system 88 based on first data from the sensor array 92 and automatically determine a root cause of the user reaction based on one or more of the first data or second data from the sensor array 92. The illustrated sensor array 92 includes internal sensors 92a (e.g., internal camera, microphone, chemical sensor, motion sensor, etc.) and external sensors 92b (e.g., external camera, microphone, chemical sensor, motion sensor, etc.). The logic 112 may also automatically update co-occupant selection criteria associated with the first occupant if the root cause is a second occupant of the mobile system 88. Although the logic 112 is shown as being located within the processor(s) 96, the logic 112 may be located elsewhere in the mobile system 88.

FIG. 8 shows a semiconductor package apparatus 114. The apparatus 114 may include logic 118 to implement one or more aspects of the method 30 (FIG. 3), the method 38 (FIG. 4), the method 50 (FIG. 5) and/or the method 56 (FIG. 6) and may be readily substituted for the semiconductor die 104 (FIG. 7), already discussed. The illustrated apparatus 114 includes one or more substrates 116 (e.g., silicon, sapphire, gallium arsenide), wherein the logic 118 (e.g., transistor array and other integrated circuit/IC components) is coupled to the substrate(s) 116. The logic 118 may be implemented at least partly in configurable logic or fixed-functionality logic hardware. In one example, the logic 118 includes transistor channel regions that are positioned (e.g., embedded) within the substrate(s) 116. Thus, the interface between the logic 118 and the substrate(s) 116 may not be an abrupt junction. The logic 118 may also be considered to include an epitaxial layer that is grown on an initial wafer of the substrate(s) 116.

### ADDITIONAL NOTES AND EXAMPLES

Example 1 may include a compatibility-enhanced shared vehicle comprising one or more surfaces defining a cabin, a plurality of sensors, a processor, and a memory including a set of instructions, which when executed by the processor, cause the shared vehicle to detect a user reaction of a first occupant of the shared vehicle based on first data from one or more of the plurality of sensors, determine a root cause of the user reaction based on one or more of the first data or second data, and update co-occupant selection criteria associated with the first occupant if the root cause is a second occupant of the shared vehicle.

Example 2 may include the shared vehicle of Example 1, wherein the instructions, when executed, cause the shared vehicle to conduct a search for the user reaction in known reaction data, and send a correlation query to the first occupant if the search is unsuccessful.

Example 3 may include the shared vehicle of Example 1, wherein the instructions, when executed, cause the shared vehicle to obtain an evaluation of the second occupant from the first occupant, and add the user reaction, the root cause and the evaluation as an entry to the co-occupant selection criteria.

Example 4 may include the shared vehicle of Example 1, wherein the instructions, when executed, cause the computing system to initiate a safety measure with respect to the shared vehicle if the root cause poses a threat to the first occupant.

Example 5 may include the shared vehicle of Example 1, wherein the plurality of sensors include one or more of an internal camera, an external camera, an internal microphone, an external microphone, an internal chemical sensor, an external chemical sensor or a motion sensor.

Example 6 may include the shared vehicle of any one of Examples 1 to 5, wherein the co-occupant selection criteria is to include co-passenger selection criteria.

Example 7 may include a semiconductor package apparatus comprising one or more substrates, and logic coupled to the one or more substrates, wherein the logic is implemented in one or more of configurable logic or fixed-functionality hardware logic, the logic coupled to the one or more substrates to detect a user reaction of a first occupant of a shared vehicle based on first data from one or more sensors associated with the shared vehicle, determine a root cause of the user reaction based on one or more of the first data or second data, and update co-occupant selection criteria associated with the first occupant if the root cause is a second occupant of the shared vehicle.

Example 8 may include the semiconductor package apparatus of Example 7, wherein the logic coupled to the one or more substrates is to conduct a search for the user reaction in known reaction data, and send a correlation query to the first occupant if the search is unsuccessful.

Example 9 may include the semiconductor package apparatus of Example 7, wherein the logic coupled to the one or more substrates is to obtain an evaluation of the second occupant from the first occupant, and add the user reaction, the root cause and the evaluation as an entry to the co-occupant selection criteria.

Example 10 may include the semiconductor package apparatus of Example 7, wherein the logic coupled to the one or more substrates is to initiate a safety measure with respect to the shared vehicle if the root cause poses a threat to the first occupant.

Example 11 may include the semiconductor package apparatus of Example 7, wherein the logic coupled to the one or more substrates is to collect the first data and the second data from one or more of an internal camera, an external camera, an internal microphone, an external microphone, an internal chemical sensor, an external chemical sensor or a motion sensor of the shared vehicle.

Example 12 may include the semiconductor package apparatus of any one of Examples 7 to 11, wherein the co-occupant selection criteria is to include co-passenger selection criteria.

Example 13 may include a method of predicting compatibility in shared vehicles, comprising automatically detecting a user reaction of a first occupant of a shared vehicle based on first data from one or more sensors associated with the shared vehicle, automatically determining a root cause of the user reaction based on one or more of the first data or second data, and automatically updating co-occupant selection criteria associated with the first occupant if the root cause is a second occupant of the shared vehicle.

Example 14 may include the method of Example 13, wherein automatically determining the root cause of the user reaction includes conducting a search for the user reaction in known reaction data, and sending a correlation query to the first occupant if the search is unsuccessful.

Example 15 may include the method of Example 13, wherein automatically updating the co-occupant selection criteria includes obtaining an evaluation of the second occupant from the first occupant, and adding the user reaction, the root cause and the evaluation as an entry to the co-occupant selection criteria.

Example 16 may include the method of Example 13, further including automatically initiating a safety measure with respect to the shared vehicle if the root cause poses a threat to the first occupant.

Example 17 may include the method of Example 13, further including collecting the first data and the second data from one or more of an internal camera, an external camera, an internal microphone, an external microphone, an internal chemical sensor, an external chemical sensor or a motion sensor of the shared vehicle.

Example 18 may include the method of any one of Examples 13 to 17, wherein the co-occupant selection criteria includes co-passenger selection criteria.

Example 19 may include at least one computer readable storage medium comprising a set of instructions, which when executed by a computing system, cause the computing system to detect a user reaction of a first occupant of a shared vehicle based on first data from one or more sensors associated with the shared vehicle, determine a root cause of the user reaction based on one or more of the first data or second data, and update co-occupant selection criteria associated with the first occupant if the root cause is a second occupant of the shared vehicle.

Example 20 may include the at least one computer readable storage medium of Example 19, wherein the instructions, when executed, cause the computing system to conduct a search for the user reaction in known reaction data, and send a correlation query to the first occupant if the search is unsuccessful.

Example 21 may include the at least one computer readable storage medium of Example 19, wherein the instructions, when executed, cause the computing system to obtain an evaluation of the second occupant from the first occupant, and add the user reaction, the root cause and the evaluation as an entry to the co-occupant selection criteria.

Example 22 may include the at least one computer readable storage medium of Example 19, wherein the instructions, when executed, cause the computing system to initiate a safety measure with respect to the shared vehicle if the root cause poses a threat to the first occupant.

Example 23 may include the at least one computer readable storage medium of Example 19, wherein the instructions, when executed, cause the computing system to collect the first data and the second data from one or more of an internal camera, an external camera, an internal microphone, an external microphone, an internal chemical sensor, an external chemical sensor or a motion sensor of the shared vehicle.

Example 24 may include the at least one computer readable storage medium of any one of Examples 19 to 23, wherein the co-occupant selection criteria is to include co-passenger selection criteria.

Example 25 may include a semiconductor package apparatus comprising means for automatically detecting a user reaction of a first occupant of a shared vehicle based on first data from one or more sensors associated with the shared vehicle, means for automatically determining a root cause of the user reaction based on one or more of the first data or second data, and means for automatically updating co-occupant selection criteria associated with the first occupant if the root cause is a second occupant of the shared vehicle.

Example 26 may include the apparatus of Example 25, wherein automatically determining the root cause of the user reaction includes means for conducting a search for the user reaction in known reaction data, and means for sending a correlation query to the first occupant if the search is unsuccessful.

Example 27 may include the apparatus of Example 25, wherein automatically updating the co-occupant selection criteria includes means for obtaining an evaluation of the second occupant from the first occupant, and means for adding the user reaction, the root cause and the evaluation as an entry to the co-occupant selection criteria.

Example 28 may include the apparatus of Example 25, further including means for automatically initiating a safety measure with respect to the shared vehicle if the root cause poses a threat to the first occupant.

Example 29 may include the apparatus of Example 25, further including means for collecting the first data and the second data from one or more of an internal camera, an external camera, an internal microphone, an external microphone, an internal chemical sensor, an external chemical sensor or a motion sensor of the shared vehicle.

Example 30 may include the apparatus of any one of Examples 25 to 29, wherein the co-occupant selection criteria is to include co-passenger selection criteria.

Thus, technology described herein may provide personalized experiences to users of autonomous or semi-autonomous vehicles, especially in autonomous fleets and shared rides. The technology may provide peace of mind to customers and enable them to be more willing to trust such services.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A shared vehicle comprising:
one or more surfaces defining a cabin;
a plurality of sensors;
a processor; and
a memory including a set of instructions, which when executed by the processor, cause the shared vehicle to:
detect a user reaction of a first occupant of the shared vehicle based on first data from one or more of the plurality of sensors;
determine a root cause of the user reaction based on one or more of the first data or second data; and
update co-occupant selection criteria associated with the first occupant if the root cause is a second occupant of the shared vehicle.

2. The shared vehicle of claim 1, wherein the instructions, when executed, cause the shared vehicle to:
conduct a search for the user reaction in known reaction data; and
send a correlation query to the first occupant if the search is unsuccessful.

3. The shared vehicle of claim 1, wherein the instructions, when executed, cause the shared vehicle to:
obtain an evaluation of the second occupant from the first occupant; and
add the user reaction, the root cause and the evaluation as an entry to the co-occupant selection criteria.

4. The shared vehicle of claim 1, wherein the instructions, when executed, cause the computing system to initiate a safety measure with respect to the shared vehicle if the root cause poses a threat to the first occupant.

5. The shared vehicle of claim 1, wherein the plurality of sensors include one or more of an internal camera, an external camera, an internal microphone, an external microphone, an internal chemical sensor, an external chemical sensor or a motion sensor.

6. The shared vehicle of claim 1, wherein the co-occupant selection criteria is to include co-passenger selection criteria.

7. A semiconductor package apparatus comprising:
one or more substrates; and
logic coupled to the one or more substrates, wherein the logic is implemented in one or more of configurable logic or fixed-functionality hardware logic, the logic coupled to the one or more substrates to:
detect a user reaction of a first occupant of a shared vehicle based on first data from one or more sensors associated with the shared vehicle;
determine a root cause of the user reaction based on one or more of the first data or second data; and
update co-occupant selection criteria associated with the first occupant if the root cause is a second occupant of the shared vehicle.

8. The semiconductor package apparatus of claim 7, wherein the logic coupled to the one or more substrates is to:
conduct a search for the user reaction in known reaction data; and
send a correlation query to the first occupant if the search is unsuccessful.

9. The semiconductor package apparatus of claim 7, wherein the logic coupled to the one or more substrates is to:
obtain an evaluation of the second occupant from the first occupant; and
add the user reaction, the root cause and the evaluation as an entry to the co-occupant selection criteria.

10. The semiconductor package apparatus of claim 7, wherein the logic coupled to the one or more substrates is to initiate a safety measure with respect to the shared vehicle if the root cause poses a threat to the first occupant.

11. The semiconductor package apparatus of claim 7, wherein the logic coupled to the one or more substrates is to collect the first data and the second data from one or more of an internal camera, an external camera, an internal microphone, an external microphone, an internal chemical sensor, an external chemical sensor or a motion sensor of the shared vehicle.

12. The semiconductor package apparatus of claim 7, wherein the co-occupant selection criteria is to include co-passenger selection criteria.

13. A method comprising:
automatically detecting a user reaction of a first occupant of a shared vehicle based on first data from one or more sensors associated with the shared vehicle;
automatically determining a root cause of the user reaction based on one or more of the first data or second data; and
automatically updating co-occupant selection criteria associated with the first occupant if the root cause is a second occupant of the shared vehicle.

14. The method of claim 13, wherein automatically determining the root cause of the user reaction includes:
conducting a search for the user reaction in known reaction data; and
sending a correlation query to the first occupant if the search is unsuccessful.

15. The method of claim 13, wherein automatically updating the co-occupant selection criteria includes:
obtaining an evaluation of the second occupant from the first occupant; and
adding the user reaction, the root cause and the evaluation as an entry to the co-occupant selection criteria.

16. The method of claim 13, further including automatically initiating a safety measure with respect to the shared vehicle if the root cause poses a threat to the first occupant.

17. The method of claim 13, further including collecting the first data and the second data from one or more of an internal camera, an external camera, an internal microphone, an external microphone, an internal chemical sensor, an external chemical sensor or a motion sensor of the shared vehicle.

18. The method of claim 13, wherein the co-occupant selection criteria includes co-passenger selection criteria.

19. At least one computer readable storage medium comprising a set of instructions, which when executed by a computing system, cause the computing system to:
detect a user reaction of a first occupant of a shared vehicle based on first data from one or more sensors associated with the shared vehicle;
determine a root cause of the user reaction based on one or more of the first data or second data; and
update co-occupant selection criteria associated with the first occupant if the root cause is a second occupant of the shared vehicle.

20. The at least one computer readable storage medium of claim 19, wherein the instructions, when executed, cause the computing system to:
conduct a search for the user reaction in known reaction data; and
send a correlation query to the first occupant if the search is unsuccessful.

21. The at least one computer readable storage medium of claim 19, wherein the instructions, when executed, cause the computing system to:
obtain an evaluation of the second occupant from the first occupant; and
add the user reaction, the root cause and the evaluation as an entry to the co-occupant selection criteria.

22. The at least one computer readable storage medium of claim 19, wherein the instructions, when executed, cause the computing system to initiate a safety measure with respect to the shared vehicle if the root cause poses a threat to the first occupant.

23. The at least one computer readable storage medium of claim 19, wherein the instructions, when executed, cause the computing system to collect the first data and the second data from one or more of an internal camera, an external camera, an internal microphone, an external microphone, an internal chemical sensor, an external chemical sensor or a motion sensor of the shared vehicle.

24. The at least one computer readable storage medium of claim 19, wherein the co-occupant selection criteria is to include co-passenger selection criteria.
